(19) United States
(12) Patent Application Publication
(10) Pub. No.: US 2024/0253831 A1
(43) Pub. Date: Aug. 1, 2024

(54) HYDROGEN PRODUCING CUBE, A DRONE BOX, AND A VEHICLE COMBINATION

(71) Applicant: H3 DYNAMICS HOLDINGS PTE. LTD., Singapore (SG)

(72) Inventors: Taras Elie WANKEWYCZ, Singapore (SG); Mark David SHUCK, Singapore (SG); Bertrand Nicolas Marie Christian GAUTHIER, Singapore (SG)

(21) Appl. No.: 18/564,578

(22) PCT Filed: May 26, 2022
(86) PCT No.: PCT/SG2022/050356

§ 371 Date: Nov. 27, 2023

(30) Foreign Application Priority Data
May 26, 2021 (WO) PCT/SG2021/050292

(51) Int. Cl. B64U 80/25; B64D 37/30; B64U 80/70; B64U 80/86; F17C 5/06

(52) U.S. Cl. CPC B64U 80/25; B64D 37/30; B64U 80/70; B64U 80/86; F17C 5/06; F17C 2265/065

(57) ABSTRACT

A hydrogen producing cube for refilling a hydrogen cylinder comprising a hydrogen cylinder holder, a compressor unit, an electrolyzer unit, and a liquefier unit.

The present application relates to a hydrogen producing cube, a trailer comprising a hydrogen producing cube, a vehicle combination comprising a trailer comprising a hydrogen producing cube, a drone box for a drone, a trailer, a vehicle combination, and a method for refilling a drone with a drone box.

It is an object of the present application to provide an improved way to make a drone ready for use.

According to a first aspect, a hydrogen producing cube for refilling a hydrogen cylinder comprising a hydrogen cylinder holder, a compressor unit, an electrolyzer unit, and a liquefier unit.

The liquefier unit is also called a liquidizer unit. The hydrogen cylinder is also called a hydrogen bottle. The electrolyzer unit is also called an electrolyzer while the compressor unit is also called a compressor for short.

The hydrogen producing cube is a standalone box. The hydrogen producing cube can be made of plastic, composites, metal materials, or a combination thereof. The hydrogen producing cube is adapted to produce hydrogen. The produced hydrogen can be filled into hydrogen cylinders or bottles. The hydrogen producing cube can have a size nearly equal to a human, although this can vary widely depending on the needed production rate.

The electrolyzer unit produces hydrogen from water and electricity. In a general sense, hydrogen can also be produced from water and a chemical. The electrolyzer unit comprises at least two electrodes. One electrode is a minus pole and the other electrode is a plus pole. The electrodes can be made of metal or carbon materials and the electrodes are dipped into the water, although the actual electrolyzer process is more complicated and can be built as fuel cell. The electrolyzer unit is connected to the electric power and to a water supply.

The compressor unit can comprise a pump or a compressing device. The compressor unit compresses the hydrogen. The compressor unit is connected to the electrolyzer unit through a hose.

The liquefier unit liquifies the hydrogen. The liquefier unit comprises a cooler. The cooler cools the hydrogen to make it liquid. The liquefier unit is connected to the compressor unit or the electrolyzer through a hose. The liquefier unit is also connected to the destination hydrogen cylinder holder.

Through this solution, a hydrogen producing cube is provided, which can be used standalone. The hydrogen producing cube has a broad application area. The hydrogen producing cube can provide hydrogen in a safe way.

According to another embodiment, the hydrogen producing cube comprises a human interface device. The hydrogen producing cube further comprises a human interface device (HID). The human interface device can accept an input from a user. The human interface device can be a touch display, a button, or a number pad. Performing an input, the user can start the hydrogen production.

The human interface device allows to input several information, for example a type of a hydrogen cylinder or a refilling level. Through the human interface device, the refilling process can be customized and fitted to individual hydrogen cylinders and use cases.

In an example embodiment, the hydrogen producing cube further comprises a status display.

The status display can be a light bulb, a LED, or a display. The status display can show to the user, if the hydrogen producing cube, in particular the cylinder holder, is ready to take up a hydrogen cylinder. The status display can also show to the user if the hydrogen cylinder is filled with hydrogen and ready to take away. For example, the status display can indicate by a red light that the hydrogen producing cube is busy and the cylinder cannot be removed. By a green light, the status display 560 can indicate to the user the hydrogen cylinder is filled and ready to take away. This example is not limited.

The status display gives the user information about the refilling process status and indicates the user how to handle the hydrogen producing cube. This improves the user experience and provides a safe way to handle the refilling process.

In an embodiment, the hydrogen producing cube further comprises a connection interface.

The connection interface can submit data comprising a required electric power, which is used by the hydrogen producing cube, to the electricity generator. Depending on the submitted data the electricity generator can power up or adapt the provided power. For example, if the electricity generator is a battery the connection interface can read a status of the battery. The status can be a state of charge or a maximal power output. In each case the connection interface can also receive data from the electricity generator. Depending on the received data, the connection interface can adjust the power consumption of the hydrogen producing cube.

Through the connection interface the hydrogen producing cube can communicate with external devices.

According to another embodiment, the hydrogen cylinder holder further comprises a moveable valve coupling element. The hydrogen cylinder holder can comprise a bottom, where a hydrogen cylinder can be placed. The hydrogen cylinder can comprise a hydrogen cylinder valve. The hydrogen cylinder valve can be opened by connecting a counterpart to the valve. In an open status of the hydrogen cylinder valve, hydrogen can flow into the hydrogen cylinder. In this embodiment, the counterpart is the moveable valve coupling element. The moveable valve coupling element can be moved along a vertical direction. Moving the moveable valve coupling element downwards the moveable valve coupling element can be connected to the hydrogen cylinder. By connecting the moveable valve coupling element the hydrogen cylinder valve is opened.

Through the moveable valve coupling element is a safe way provided to connect the hydrogen cylinder to the hydrogen cylinder holder. The hydrogen cylinder valve is opening when the moveable valve coupling element is connected. This prevents the outflow of hydrogen.

In a further embodiment the hydrogen cylinder holder comprises a moveable shield. The moveable shield can be made of plastic, composite, or metal material. The moveable shield prevents the user to interact with the hydrogen cylinder while the refilling process takes place. An unintended disconnection initiated by the user can be avoided.

In an example embodiment, the hydrogen producing cube further comprises electric cable. The electric cable is connected to the hydrogen producing cube and to an electricity generator. The electricity generator can be a utility grid, an external generator, a battery, or a dynamo of a vehicle.

According to another embodiment, the hydrogen producing cube further comprises a water hose. The water hose is connected to the hydrogen producing cube. The hydrogen producing cube soaks water from a water storage. The water storage can be a utility supply, water tank, a lake or stream. The water hose improves the application area and improves the standalone ability by using local water sources.

In a further example embodiment, the hydrogen producing cube further comprises a water tank. In case the hydrogen producing cube cannot be connected to a local water source, the built-in water tank can provide water to the electrolyzer unit.

The hydrogen producing cube further comprises an energy storage. In case the hydrogen producing cube cannot be connected to an external generator, the built-in energy storage can provide energy to the electrolyzer unit.

According to a second aspect, a trailer comprises a hydrogen producing cube, wherein the trailer further comprises connections means, a tow bar and a trailer cable. The hydrogen producing cube can be mounted to the trailer. Mounting the hydrogen producing cube is not limited to a specific trailer. The trailer can comprise an energy storage. Mounting the hydrogen producing cube to the trailer increases the application area. The hydrogen producing cube can be moved flexible to different use cases.

According to a third aspect, a vehicle combination comprises a trailer and a hydrogen producing cube, wherein the vehicle combination comprises a vehicle, wherein the vehicle comprises a motor, a generator, a generator cable, an electric power storage.

To provide energy to the hydrogen producing cube, the vehicle comprises a motor. The motor can be a combustion engine. Fuel to operate the motor can be stored in a gas tank of the vehicle. The motor can provide mechanic energy to move the car. The motor also provides mechanic energy to drive the generator. The generator produces electric power. The electric power is stored in an electric power storage. The electric power storage can provide electric power to the trailer and the hydrogen producing cube. Proving electric energy from a vehicle to the trailer and the hydrogen producing cube improves the independence of the drone box and the field of operation.

According to a fourth aspect, a drone box for a drone comprises a compressor unit, a compressor hose, a hydrogen producing unit, a hydrogen producing unit hose, a hydrogen tank, a hydrogen tank hose, and a platform.

The drone can be an unmanned, uninhabited, or unpiloted aerial vehicle (UAV). The drone is configured to fly autonomously. The drone is configured to start and land autonomously. The drone can be coupled to the drone box. The drone can also detect the drone box. The drone can communicate with the drone box.

The drone can comprise a fuel tank and a fuel cell. The fuel tank can be a hydrogen tank. The fuel cell generates electric power from hydrogen.

For producing hydrogen, the drone box comprises the hydrogen producing unit. The hydrogen producing unit can be an electrolyzer. The compressor unit can pump water into the hydrogen producing unit. The compressor unit can be a water pump. The hydrogen producing unit stores the hydrogen in a hydrogen tank. The hydrogen tank can be a high-pressure tank.

The compressor unit is connected through the compressor hose to the hydrogen producing unit. The hydrogen producing unit is connected to the hydrogen tank through the hydrogen producing unit hose. The hydrogen tank can be connected to the drone through the hydrogen tank hose.

Hydrogen is a material to store energy. One benefit of hydrogen is that it can be refilled fast. This reduces the refill time of the drone. Reducing the refill time means improving the flight time in a predefined period. This allows different use cases of a drone.

For example, the drone can land on the platform. The stored hydrogen in the hydrogen tank of the drone box can be directed into the fuel tank of the drone. After taking up hydrogen the drone is ready to fly.

According to an embodiment, the drone box further comprises a water tank

The water tank provides water. The compressor unit can pump water from the water tank to the hydrogen producing unit. The water tank is arranged in the drone box. In another embodiment, the water tank can be external to the drone box and connected to the drone box, in particular to the pump.

The built-in water tank in the drone box makes the drone box compact and easy to use. In case the use case of the drone changes or the water tank is empty, the drone box can be changed.

The platform is mounted to a scissor lift in an embodiment.

The platform for the drone can be moveable. In particular, the platform can be moved upwards and downwards. The upwards and downwards movement is performed by a scissor lift, which is mounted to the platform.

The drone can be moved downwards into the drone box. This allows reconfiguring the drone. Further, the drone can be fastened inside the drone box. This allows to store the drone in the drone box and to move the drone with the drone box.

In a further embodiment, the drone box comprises a cover, wherein the cover has a shape of a hood in cross-section

The cover is arranged on top of the drone box. In closed status, the cover covers the platform. The cover can be made of a weather-resistant material. The cover can be moved from a closed status to an open status. The open status unblocks the drone and/or the platform. The cover can be moved sideways. Sideways means to move the cover along a plane of the platform.

The cover allows to enclose the drone. This improves the weather-resistant of the drone.

According to another embodiment, the hydrogen producing unit is an electrolyzer.

The electrolyzer can be a polymer electrolyte membrane (PEM). The polymer electrolyte membrane (PEM) is the electrolysis of water in a cell equipped with a solid polymer electrolyte (SPE) that is responsible for the conduction of protons, separation of product gases, and electrical insulation of the electrodes.

In a general sense, the electrolyzer is not limited to the PEM. Most electrolyzer are alkaline electrolyzer.

Through this solution, hydrogen can be produced from water and electric power. This improves the independence of the drone box. Water can be provided nearly everywhere on earth. The use case of the drone box is not limited.

The drone box further comprises modular changeable modules in an embodiment.

The drone box can comprise several different modules. The drone box can be configured depending on the use case. The modules can be combined in any way.

This improves the adaptability and the application of a drone box. Improving the adaptability and the application of a drone box also improves the use case of a drone.

In an example embodiment, the modular changeable modules are a payload module, a power module, a power module, a central system module, a heating module, a cooling module, and/or a wall module.

The payload module can provide a bomb load, weapons, sensors, a payload, or a camera to the drone. In particular, the payload module can provide technical equipment to the drone. The payload module can also mount or install the part to the drone. The payload module allows configuring the drone depending on the use case of the drone. This improves the field of application.

The power module can provide electric power to the drone and the modules of the drone box. The power module can also control the compressor unit, the hydrogen producing unit, and the fuel tank. In case the drone is driven by a battery, the power module can provide electric power and recharge the battery of the drone. In case the drone is hydrogen driven, the power module controls the compressor unit, the hydrogen producing unit, the fuel tank, and the refilling process of the drone.

The central system module controls the heating module, the cooling module, and the wall module. The central system module can regulate the heat or coolness, which is provided.

The heating module can provide heat. The heating module is connected to the wall module. Heating the drone box can de-ice the drone box and the drone.

The cooling module can provide coolness. The cooling module is connected to the wall module. The cooling module allows cooling the drone box and the drone. Regulating the temperature of the drone can be important for the durability of components of the drone.

The wall module can provide heat or coolness to the drone box. Through the wall module, the drone box can be air-conditioned. This solution provides regulation of the temperature of the drone box and improves the durability of the drone box in extreme weather conditions.

The drone box further comprises a tethering module with a tethering cable.

The tethering module communicates with the drone. The tethering module can receive status information from the drone and send commands to the drone. The tethering module comprises the tethering cable, which is connected to the drone. This means the drone is wired, even while flying. This can be required due to restrictions.

The power module can also provide energy to the drone through the tethering cable. This improves the flight time of the drone.

According to another embodiment, the hydrogen tank is exchangeable

The hydrogen tank of the drone box can be changeable. This can be important if the drone box is used to refill several drones and the hydrogen producing unit is producing less hydrogen than the hydrogen, which is consumed.

The drone box further comprises a liquefier. The liquefier is also called a liquidizer.

A liquefier is a device to convert gaseous hydrogen to liquid hydrogen. Liquid hydrogen has a high energy density.

Using liquid hydrogen for refilling the drone increases the energy, which can be stored inside a specific type of fuel tank on the drone. This leads to an improved flight time.

According to a fifth aspect, a trailer comprises a drone box, as described above, wherein the trailer further comprises connections means, a tow bar, and a trailer cable.

Mounting a drone box to a trailer improves the flexibility and the field of application of a drone box. This leads to an improved field of application of the drone.

According to another embodiment, the drone box is exchangeable

The drone box, which is mounted to the trailer can be changed. Depending on the use case of the drone box or the drone, the drone box can be changed. The trailer with the drone box can be adapted to any use case.

According to a sixth aspect, a vehicle combination comprises a trailer, as described above, and a drone box, as described above, wherein the vehicle combination further comprises a vehicle, wherein the vehicle comprises a motor, a generator, a generator cable, and electric power storage.

To provide energy to the drone box the vehicle comprises a motor. The motor can be a combustion engine. Fuel to operate the motor can be stored in a gas tank of the vehicle. The motor can provide mechanic energy to move the car. The motor also provides mechanic energy to drive the generator. The generator produces electric power. The electric power is stored in an electric power storage. The electric power storage can provide electric power to the trailer and the drone box.

Proving electric energy from a vehicle to the trailer and the drone box improves the independence of the drone box and the field of operation.

According to a seventh aspect, a method for refilling a drone with a drone box comprises in a first step pumping water from a water tank to a hydrogen producing unit and in a further step producing hydrogen in the hydrogen producing unit, liquefying the hydrogen in a liquefier, storing the hydrogen in a hydrogen tank, refilling the drone with hydrogen from the hydrogen tank.

This solution provides a method for refilling a drone with a drone box. Through this method, the refilling process is improved. This leads to a reduced time while the drone is on the ground. Further, this method improves the flexibility of the drone in its configuration.

The method comprises in a further step attaching a payload to the drone with a payload module

Adding a payload to the drone improves the use cases, the drone can be used for. The drone can transport a payload. Unmanned transportation improves the safety of the crew.

The application provides another improved trailer for refuelling a cylinder.

The trailer includes a box body for storing equipment. The box body is mounted on a trailer chassis with wheels.

The equipment includes a water reservoir, an electrolyzer unit, a hydrogen gas buffer unit, a compressor unit, a hydrogen gas buffer bunker unit, a refuelling connector, a controller, and a power supply.

The water reservoir is used for storing liquid water, which can be unfiltered.

The electrolyzer unit later transforms the filtered water into hydrogen gas.

After this, the hydrogen gas buffer unit stores the dried hydrogen gas from the hydrogen dryer at low pressure.

The compressor unit then increases the pressure of the hydrogen gas from the hydrogen gas buffer unit to high pressure.

The hydrogen gas buffer bunker unit later stores the compressed hydrogen gas, which is at high pressure.

The refuelling connector is used for connecting the hydrogen gas from the hydrogen gas buffer bunker unit to an empty cylinder for refuelling.

The controller, such as a programmable logic controller (PLC), send commands or instructions to the equipment via communication channels for coordinating operations of the equipment.

The power supply provides electrical power to components of the equipment.

The mobile trailer provides another means to generate hydrogen gas in a convenient and safe manner.

Referring to the equipment, it often includes a reverse osmosis filter for removing contaminants from the water in the water reservoir, which can be unfiltered.

The electrolyzer unit can be placed or attached to a plurality of a wire rope isolators for reducing or preventing unwanted vibrations from reaching the electrolyzer unit.

A hydrogen dryer can then be provided for removing humidity from the hydrogen gas that is produced by electrolyzer unit.

A safety valve is often provided for preventing any pressure in the refuelling connector from surging above a predetermined limit.

A start/stop button is often used for actuating or controlling the refuelling of the cylinder.

One or more hydrogen pipes is often provided between parts of the equipment for allowing hydrogen gas to flow from one end to another end of the pipe or from one component to another component of the equipment.

The box body often includes a door for allowing an operator to add water into the water reservoir.

A mechanical ventilation can be provided to the box body for removing any leaked hydrogen from the box body to mitigate or reduce risks related to leaked hydrogen.

The box body often includes a hydrogen leak detector for measuring the presence of the concentration of hydrogen in the air inside the box body.

The application also provides a vehicle combination that includes the above-mentioned trailer, a motor for moving the trailer, a generator for generating electrical energy, a generator cable for receiving the electrical energy, and an electric power storage for receiving the electrical energy from the generator and for providing the electrical energy to the trailer.

Embodiments of the application will now be described with reference to the attached drawings, in which the same reference numerals denominate the same or similar features.

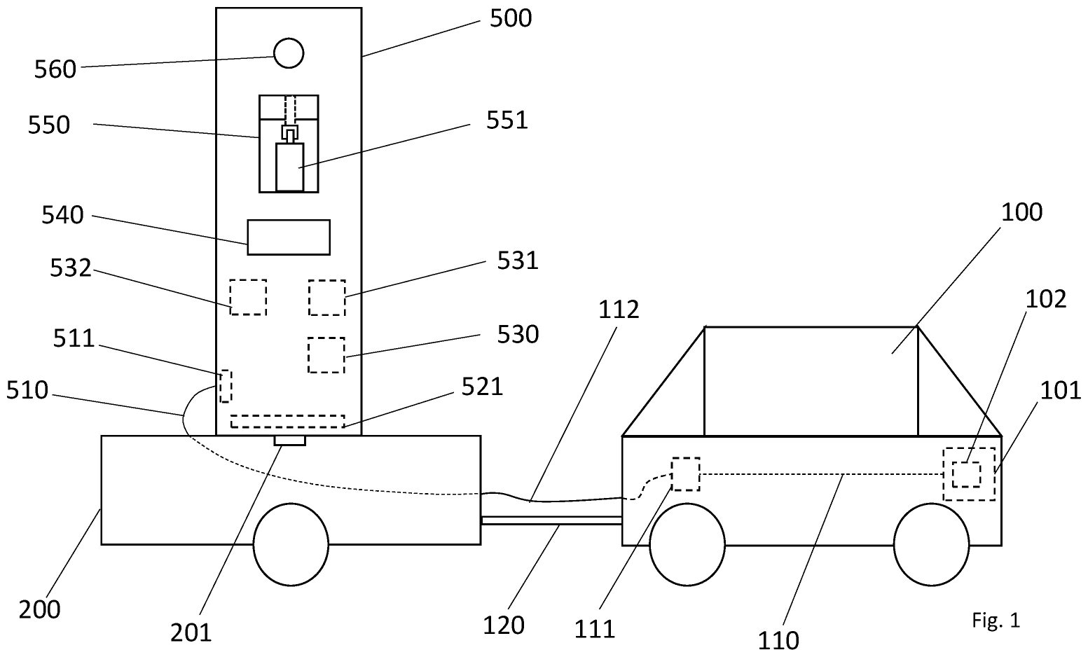

FIG. 1 shows the hydrogen producing cube mounted to a trailer,

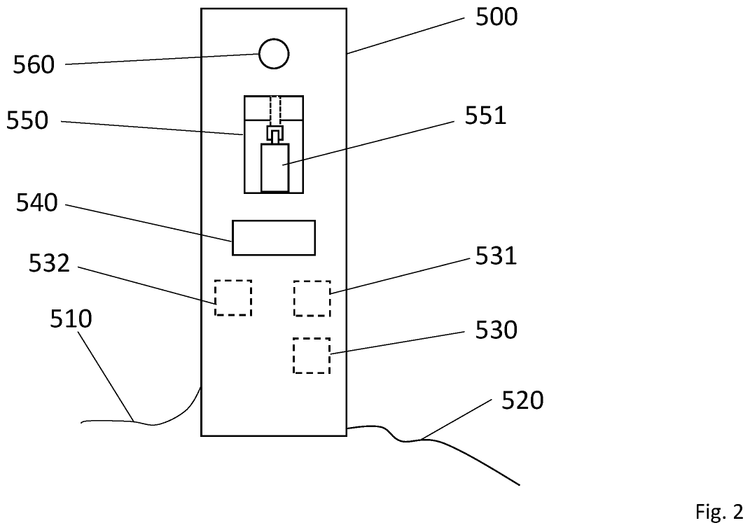

FIG. 2 shows a schematic front view of a hydrogen producing cube with an electric cable and a water hose,

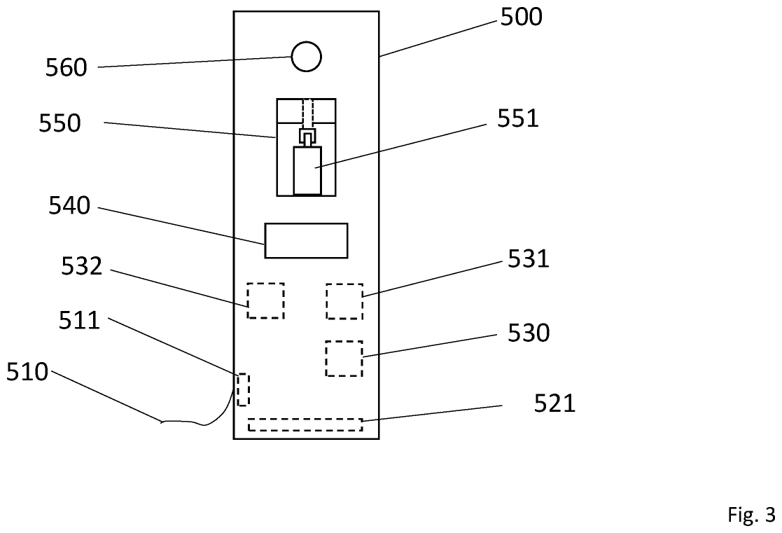

FIG. 3 shows a schematic front view of a hydrogen producing cube with an electric cable, a connection interface, and a water tank,

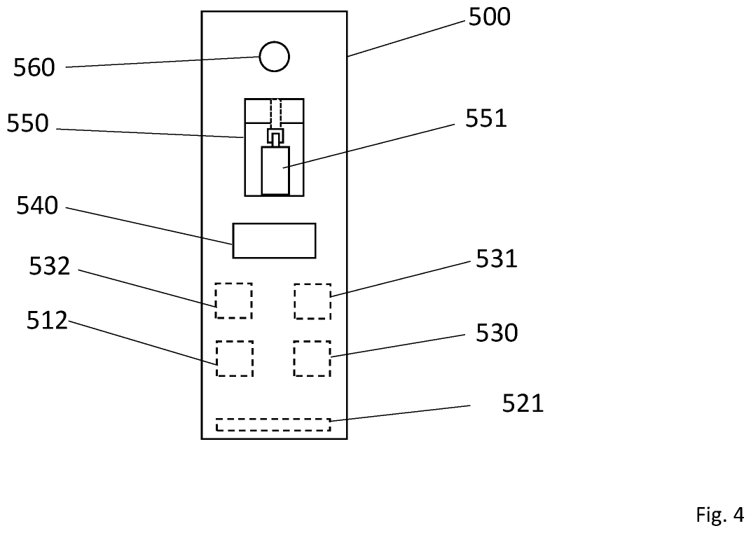

FIG. 4 shows a schematic front view of a hydrogen producing cube with an energy storage and a water tank,

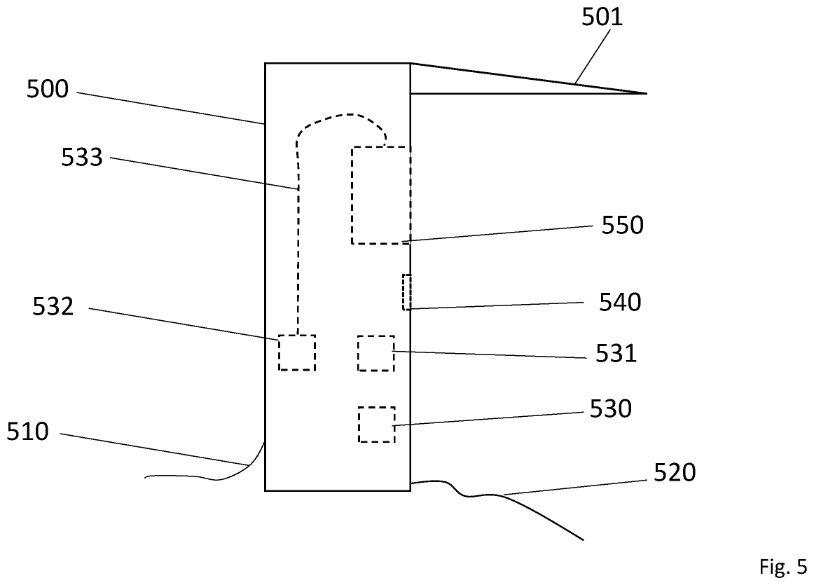

FIG. 5 shows a schematic side view of a hydrogen producing cube with an electric cable, a water hose, and a canopy,

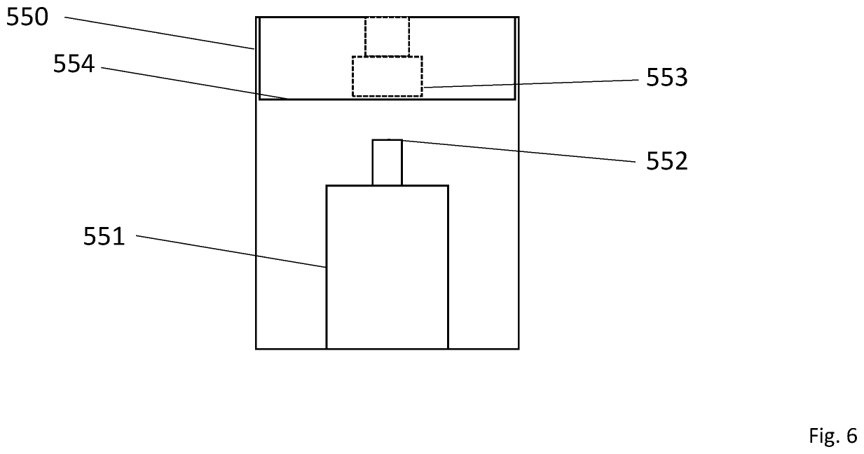

FIG. 6 shows a schematic view of a hydrogen cylinder holder in an open status,

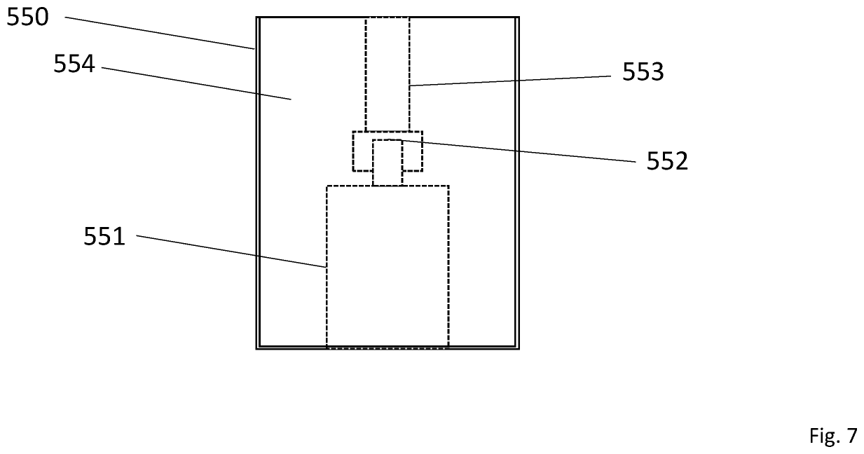

FIG. 7 shows a schematic view of a hydrogen cylinder holder in a close status,

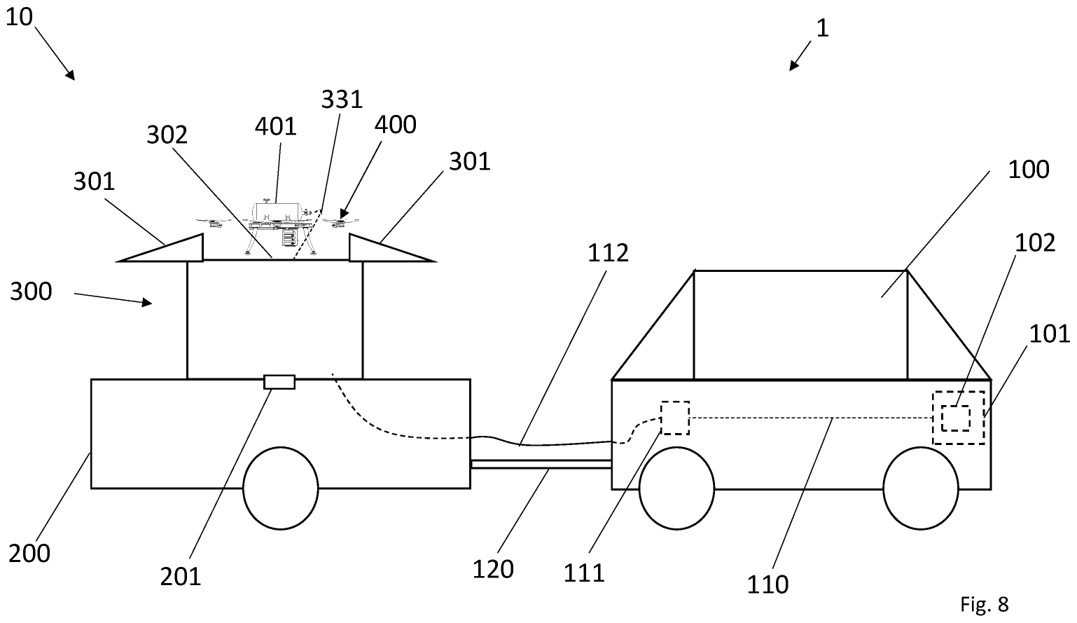

FIG. 8 shows a schematic view of a vehicle combination with a drone box,

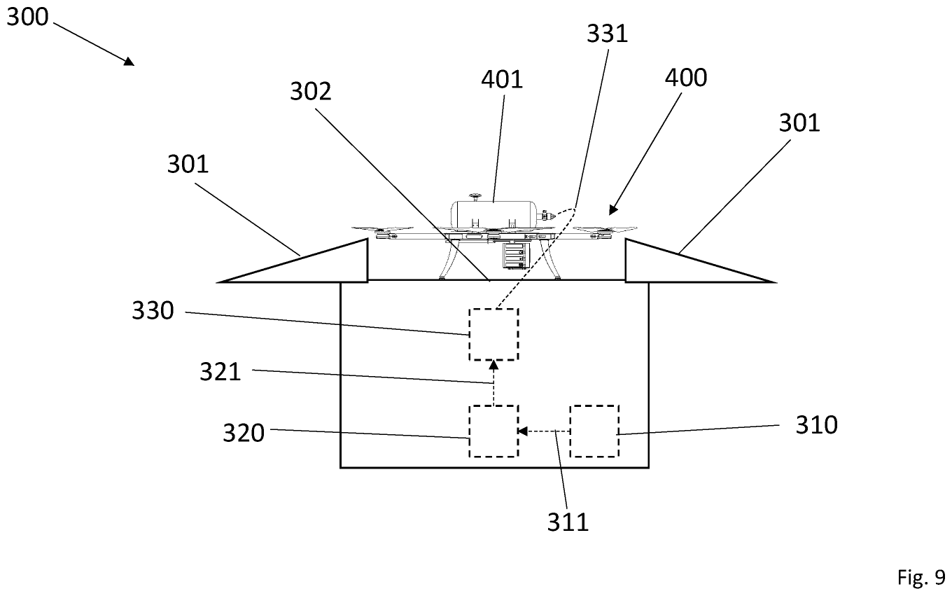

FIG. 9 shows a schematic view of a drone box while refilling a drone,

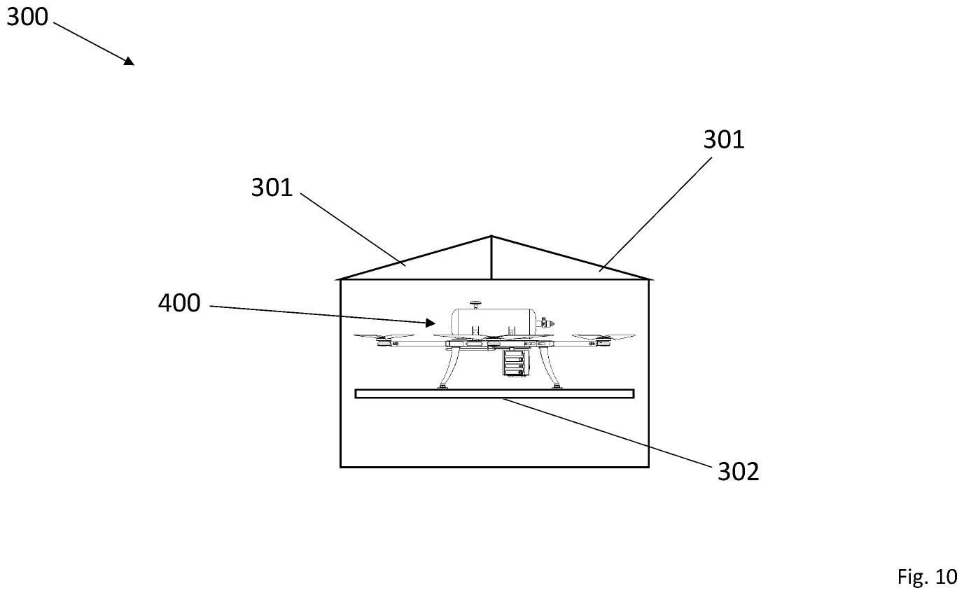

FIG. 10 shows a schematic cross section view of a drone box in closed status with a drone taken up,

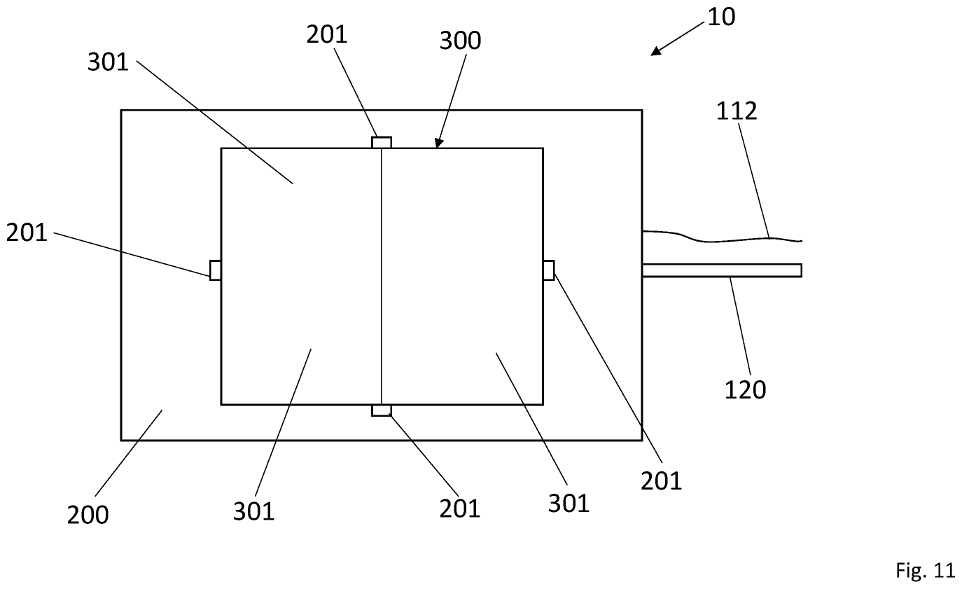

FIG. 11 shows a schematic top view of a trailer with a drone box,

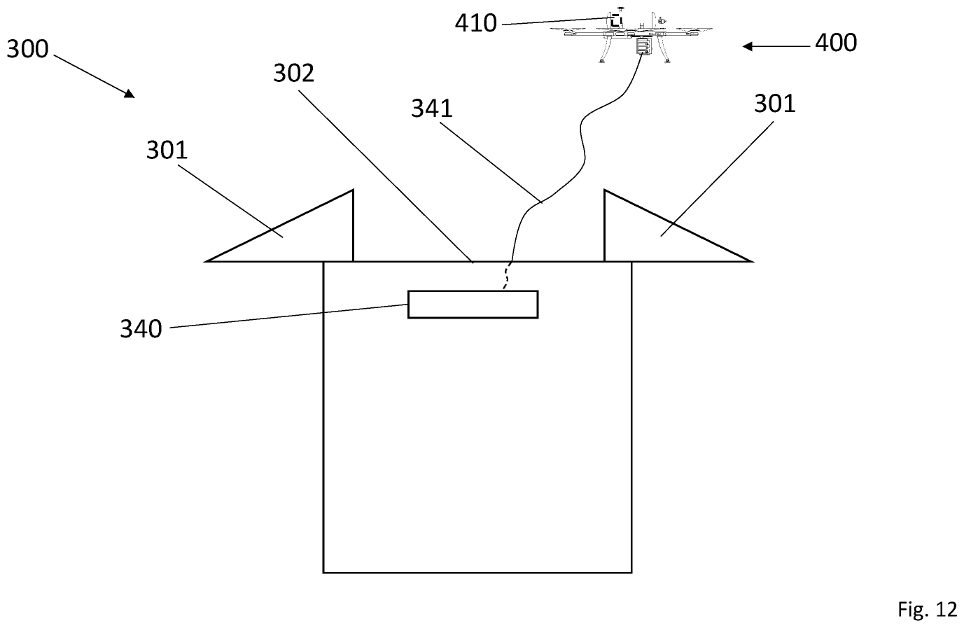

FIG. 12 shows a schematic view of a drone box with a tethering module connected to a drone,

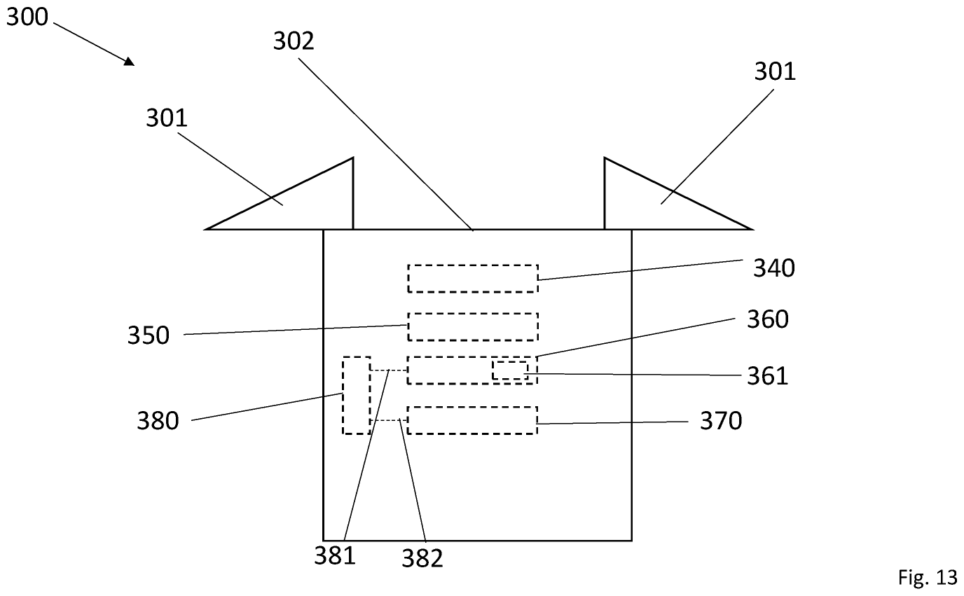

FIG. 13 shows a schematic view of a drone box,

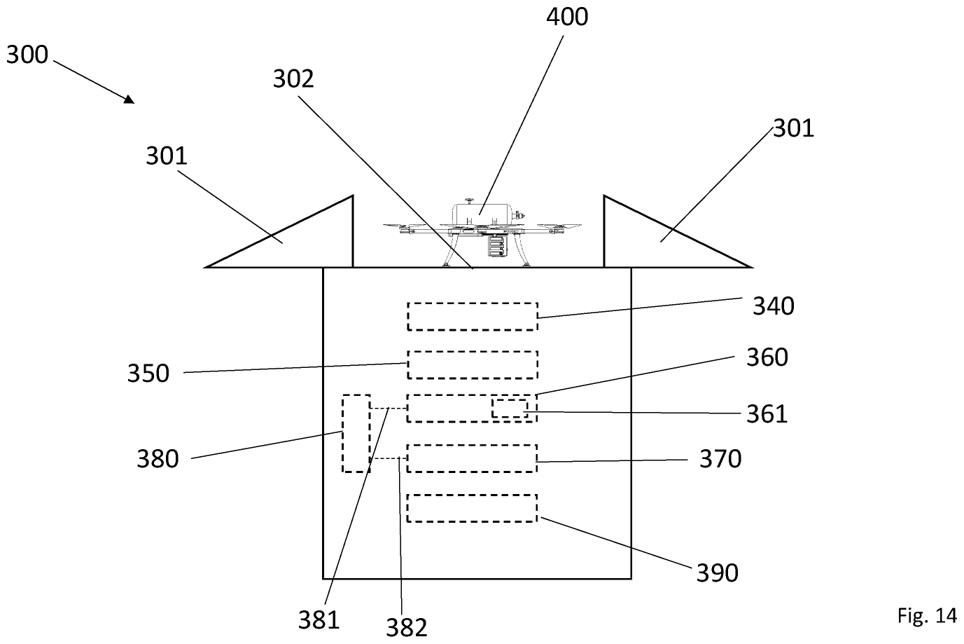

FIG. 14 shows a schematic view of a drone box with a payload module,

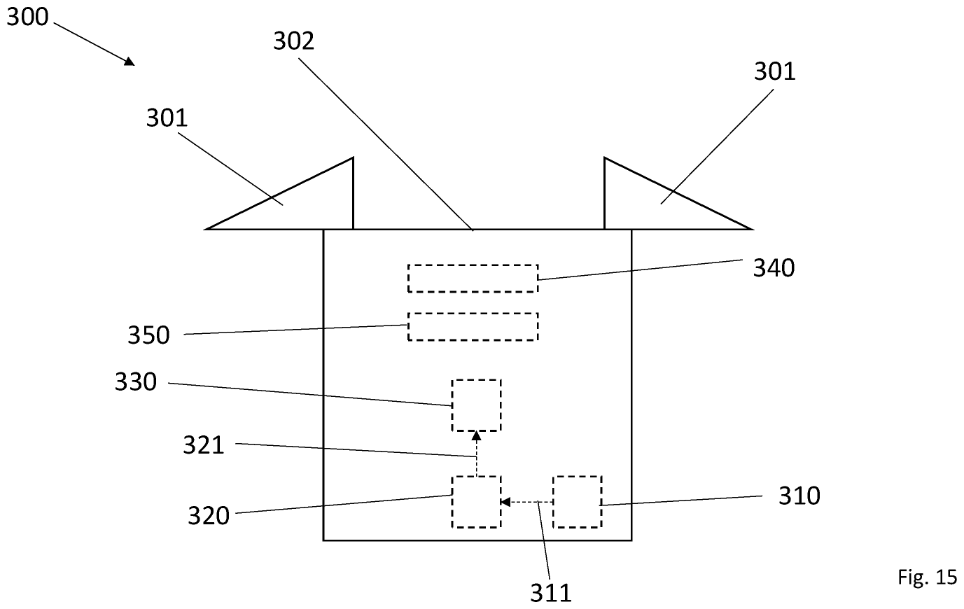

FIG. 15 shows a schematic view of drone box with tethering module, a power module, a compressor, a hydrogen producing unit, and a hydrogen tank,

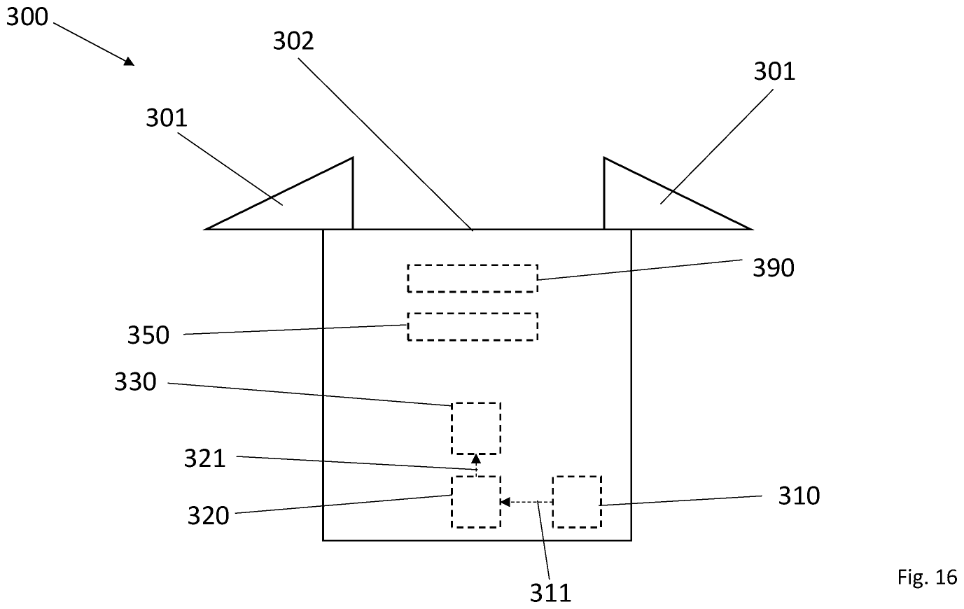

FIG. 16 shows a schematic view of drone box with a payload module, a power module, a compressor, a hydrogen producing unit, and a hydrogen tank,

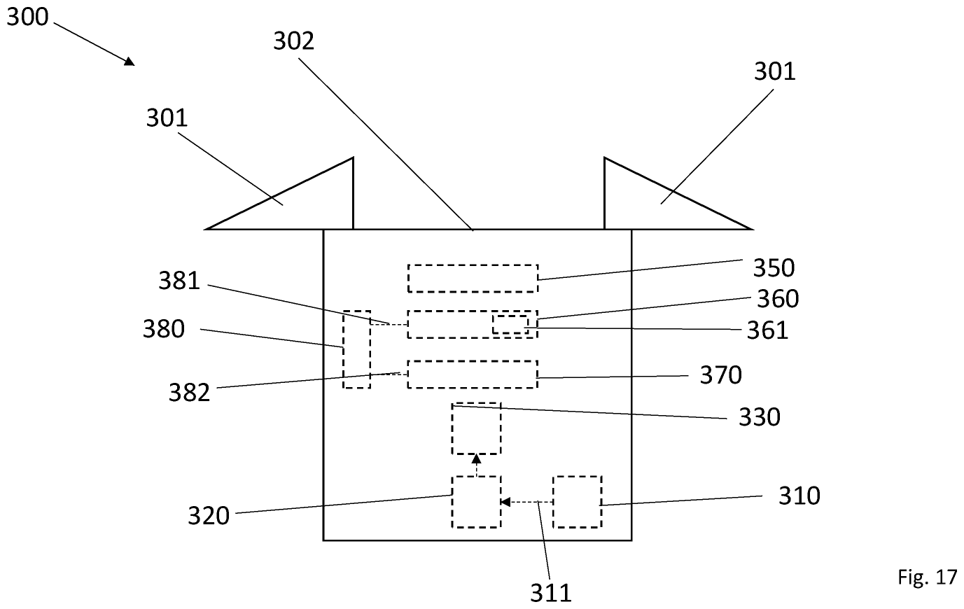

FIG. 17 shows a schematic view of drone box with a power module, a heating module, a cooling module, a wall module, a compressor, a hydrogen producing unit, and a hydrogen tank, and

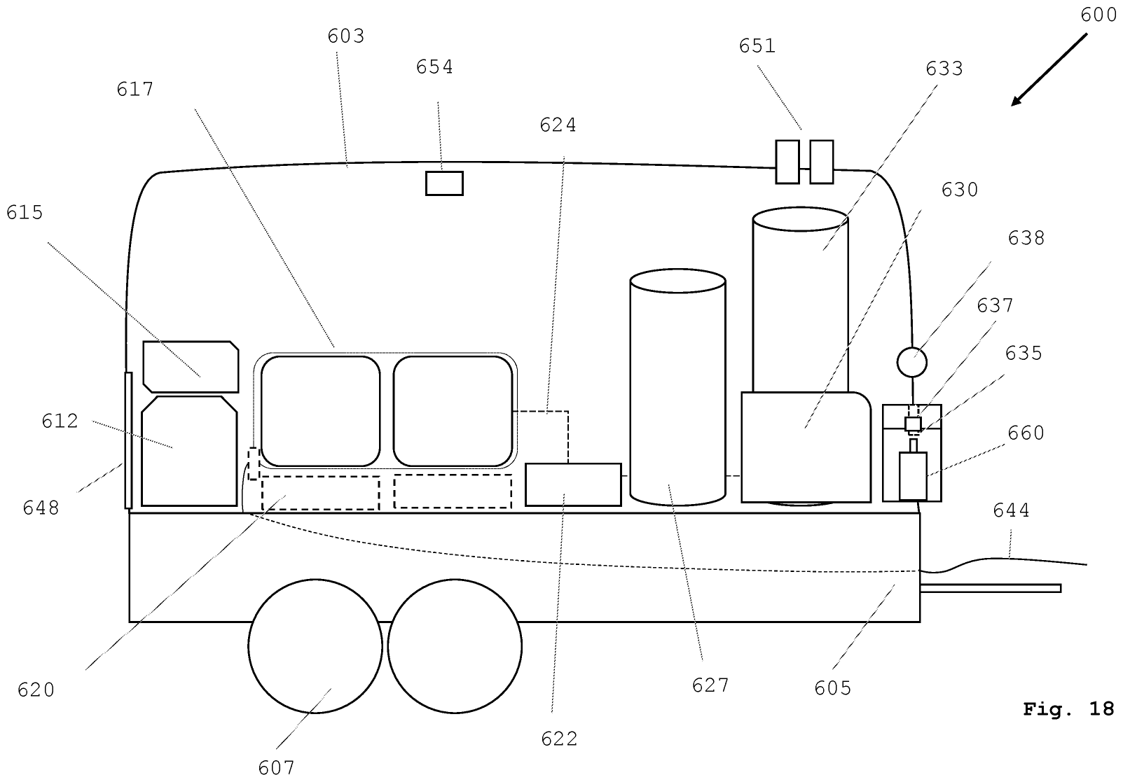

FIG. 18 shows another trailer.

Some parts of the embodiments, which are shown in the Figs. below, have similar parts. The similar parts may have the same names or the similar part numbers. The description of such similar parts also applies by reference to other similar parts, where appropriate, thereby reducing repetition of text without limiting the disclosure.

FIG. 1 shows the hydrogen producing cube 500 mounted to a trailer 200, which is town by a vehicle 100.

The vehicle 100 is a towing vehicle. The vehicle can be a truck or a car. The vehicle 100 comprises a motor 101. The motor 101 can be a combustion engine. The motor 101 provides power to move the vehicle 100. The motor 101 also provides power to a generator 102.

The generator 102 converts mechanical energy into electric energy. The generator 102 is mechanically connected to the motor 101. The generator 102 can be coupled to the motor 101. The generator 102 can be part of the motor 101 or can be separated to the motor 101. The electric energy provided through the generator 102 is taken up by an electric power storage 111. The electric power storage 111 is connected with generator cables 110 to the generator 102. The electric power storage 111 is a battery. The electric power storage 111 is arranged inside the vehicle 100. In an embodiment, which is not shown here, the electric power storage 111 can be arranged inside the trailer 200.

The power storage 111 is connected with a trailer cable 112 to the trailer 200. In an embodiment, not shown here, the generator 102 can be directly connected to the trailer 200.

The trailer 10 is coupled to the vehicle 100 with a tow bar 120. The tow bar 120 is arranged on a back of the vehicle 100.

The trailer 200 comprises connection means 201 to take up the hydrogen producing cube 500.

The vehicle 100 can provide energy to the trailer 200. The hydrogen producing cube 500 is mounted to the trailer through connections means 201. Further, the hydrogen producing cube 500 is electrically connected to the trailer through the electric cable 510. This solution provides the ability to use the hydrogen producing cube 500 flexible and in different positions.

FIG. 2 shows a schematic front view of a hydrogen producing cube 500 with an electric cable 510 and a water hose 520.

The electric cable 510 is connected to the hydrogen producing cube 500 and to an electricity generator, which is not shown here. The electricity generator can be an external generator, a battery, or a dynamo of a vehicle. The water hose is connected to the hydrogen producing cube 500. The hydrogen producing cube 500 soaks water from a water storage, which is not shown here. The water storage can be a utility, water tank, stream or a lake.

The electric cable 510 and the water hose 520 are further connected to the electrolyzer unit 530. The electrolyzer unit 530 takes up water from the water hose 520. The electrolyzer unit 530 comprises at least two electrodes, which are not shown here. The electrolyzer unit 530 is a device in which a chemical reaction, i.e., a conversion of substances, is brought about with the aid of electric current. Electrolysis takes place.

Produced hydrogen by the electrolyzer unit 530 is forwarded to a compressing unit 531. The compressing unit 531 compresses the produced hydrogen. Compressed hydrogen is further forwarded to a liquefying unit 532. The liquefying unit 532 converts the gas hydrogen into liquid hydrogen. The liquefying unit 532 comprises a cooler to cool down the compressed hydrogen.

The hydrogen producing cube 500 further comprises a human interface device (HID) 540. The human interface device 540 can accept an input from a user. The human interface device 540 can be a touch display, a button, or a number pad. Performing an input, the user can start the hydrogen production.

The liquid hydrogen is forwarded to a cylinder holder 550. The cylinder holder 550 takes up a hydrogen cylinder 551. The hydrogen cylinder 551 can store liquid hydrogen. The hydrogen cylinder 551 is also called a hydrogen cylinder.

Further, the hydrogen producing cube 500 comprises a status display 560. The status display 560 can be a light bulb, a LED, or a display. The status display 560 can show to the user, if the hydrogen producing cube, in particular the cylinder holder 550, is ready to take up a hydrogen cylinder 551. The status display can also show to the user if the hydrogen cylinder 551 is filled with hydrogen and ready to take away. For example, the status display can indicate by a red light that the hydrogen producing cube is busy and the cylinder cannot be removed. By a green light, the status display 560 can indicate to the user the hydrogen cylinder 551 is filled and ready to take away. This example is not limited.

FIG. 3 shows a schematic front view of a hydrogen producing cube 500, as shown in FIG. 2, with an electric cable 510, a connection interface 511, and a water tank 520.

The optional connection interface 511 is adapted to communicate with electricity generator, which is not shown here. The connection interface 511 can submit data comprising a required electric power, which is used by the hydrogen producing cube 500, to the electricity generator. Depending on the submitted data the electricity generator can power up or adapt the provided power. For example, if the electricity generator is a battery the connection interface 511 can read a status of the battery. The status can be a state of charge or a maximal power output. In each case the connection interface 511 can also receive data from the electricity generator. Depending on the received data, the connection interface 511 can adjust the power consumption of the hydrogen producing cube 500.

The hydrogen producing cube 500 can also comprise the water tank 521. The water tank 521 can be additional or alternatively to the water hose 520. The water tank 520 can be filled with water. The water tank 520 stores the water, which is used by the electrolyzer unit 530 to produce hydrogen. Mounting the water tank to a bottom of the hydrogen producing unit 500 stabilizes the hydrogen producing unit 500.

FIG. 4 shows a schematic front view of a hydrogen producing cube 500, as shown in FIG. 3, with an energy storage 512 and the water tank 521.

The hydrogen producing cube 500 can additionally or alternatively to the electric cable comprise an energy storage 512.

The energy storage can be charged and take up energy. The energy storage can comprise the connection interface 511. The energy storage 512 provides energy to the electrolyzer unit 530, the human interface device 540, to the status display 560.

The hydrogen producing cube can be a standalone. The energy storage 512 provides power and the water tank 521 provides water to produce hydrogen.

FIG. 5 shows a schematic side view of a hydrogen producing cube with an electric cable 510, a water hose 520, and a canopy 501.

The canopy 501 can be a rain shield or a sun shield. The canopy is mounted to the hydrogen producing unit 500. The canopy 501 can be foldable or moveable. Folding or moving the canopy in a transportation position is useful for transportation. The canopy can be made of plastic or cloth material. The canopy is additionally. The canopy can also be mounted to the embodiments described above.

The hydrogen producing cube 500 further comprises a hydrogen hose 533. The hydrogen hose 533 is connected with the liquefier unit 532 and the hydrogen cylinder holder 550. The hydrogen cylinder holder 550 can be connected to a hydrogen cylinder 551. The hydrogen hose 533 forwards the hydrogen from the liquefier unit 532 into the hydrogen cylinder 551, it the hydrogen cylinder 551 is connected.

FIG. 6 shows a schematic view of a hydrogen cylinder holder 550 in an open status.

The hydrogen cylinder holder 550 comprises a bottom, which is not shown here, where the hydrogen cylinder 551 can be placed. The hydrogen cylinder 551 comprises a hydrogen cylinder valve 552. The hydrogen cylinder valve 552 can be opened by connecting a counterpart to the valve. In an open status of the hydrogen cylinder valve 552, hydrogen can flow into the hydrogen cylinder 551. In this embodiment, the counterpart is a moveable valve coupling element 553. The moveable valve coupling element 553 can be moved along a vertical direction. Moving the moveable valve coupling element 553 downwards the moveable valve coupling element 553 can be connected to the hydrogen cylinder 551. By connecting the moveable valve coupling element 553 the hydrogen cylinder valve 552 is opened.

The hydrogen cylinder holder 550 further comprises a moveable shield 554. The moveable shield 554 is arranged vertically parallel to the front surface of the hydrogen producing cube 500. The moveable shield 554 is adapted to move upwards and downwards. In an initial state, the moveable shield 554 is moved upwards. In this state, a user can place the hydrogen cylinder 551 inside the hydrogen cylinder holder 550. While the refilling process takes place the shield is moved downwards in a closed position.

FIG. 7 shows a schematic view of a hydrogen cylinder holder 550, as shown in FIG. 6, in a close status.

When the user starts the refilling process through the human interface device 540 the moveable shield 554 moves downwards and the moveable valve coupling element 553 is connected to the hydrogen cylinder 551. For safety reasons the shield protects the users and stops the user from moving the hydrogen cylinder 551.

Once the refilling process is done the status display 560 lights up green, the moveable valve coupling element 553 is disconnected from the hydrogen cylinder 551, and the moveable shield 554 is moving upwards in the open status and the user can remove the hydrogen cylinder.

The hydrogen producing cube 500 can produce hydrogen and fill the produced hydrogen into hydrogen cylinder 551. The filled hydrogen cylinder 551 can be used in a drone box 300 to provide hydrogen to a drone 400. For example, the drone box 400 can take up one or more hydrogen cylinders 551. For safety reasons, the hydrogen cylinders 551 can have a size of 2 to 20 liters in volume. The example is not limited to the size of the hydrogen cylinder 551.

The user, who wants to refill a hydrogen cylinder 551, places the hydrogen cylinder into the hydrogen cylinder holder 550, wherein the moveable shield 554 is in the open status. Additionally, the status display 560 can indicate a ready status of the hydrogen producing cube by showing for example a green light.

If the user has placed the hydrogen cylinder 551 in the hydrogen cylinder holder 550, the user initiates the refilling by inputting information through the human interface device 540. Inputting can be pressing a start button. Inputting information can also comprise selecting a type or a size of the hydrogen cylinder 551. In an example, the user can also input a desired filling level. After inputting the required information and pressing a start button, the moveable shield 554 moves into the close position.

In a next step the moveable valve coupling element 553 moves downwards and connects to the hydrogen cylinder 551, in particular to the hydrogen cylinder valve 552. Through connecting the moveable valve coupling element 553 to the hydrogen cylinder valve 552, the hydrogen cylinder valve 552 is opened. For example, the hydrogen producing cube 500 can determine a pressure inside the hydrogen cylinder 551. Depending on the determined pressure, the hydrogen producing cube 500 can calculate a filling state. Depending on the filling state, the size, the type, and/or the desired filling level of the hydrogen cylinder 551 the hydrogen producing unit 500 can calculate an amount of hydrogen, which is needed to refill the cylinder. In another embodiment the hydrogen producing unit can comprise a pressure valve, which cuts of the connection to the hydrogen cylinder if a certain pressure is reached. This certain pressure can define a cylinder is filled status.

In a next step, the hydrogen producing process is initiated. If the optional connection interface 511 is built in the connection interface will communicate with the external electricity generator to power up the generator and to submit a calculated power usage.

At the same time or afterward water is pumped into the electrolyzer unit 530. Depending on the embodiments, which are described above, the water can be pumped from an external source or the build-in water tank 521 into the electrolyzer unit 530.

Through applying a voltage to the electrodes of the electrolyzer unit 530 hydrogen is produced. The produced oxygen, which is not used, can be forwarded to the environment through an exhaust. The produced hydrogen is forwarded through a hose to the compressing unit 531.

The compressing unit 531 compresses the hydrogen. Through compressing the hydrogen, the hydrogen can be stored in a more compact hydrogen cylinder 550. The compressed hydrogen is further forwarded to the liquefying unit 532.

The liquefying unit 532 cools the hydrogen until the hydrogen is liquid.

In a next step, the hydrogen is forwarded from the liquefier unit 532 to the hydrogen cylinder holder 550. The refill process is started by inputting information through the human interface device 540. The human interface device 540 comprises at least a start button. Pressing the start button starts the refill process. The hydrogen cylinder 551 can be placed in the hydrogen cylinder holder 550. The hydrogen cylinder holder 550, in particular the moveable valve coupling element 553 is connected to the hydrogen cylinder 551 by moving downwards. Further, the optional moveable shield 554 moves downwards in the close status. The optional status display 560 can indicate that the work is in progress.

When the hydrogen cylinder 551 is refilled, the status display 560 can indicate that the process is complete. Further, the moveable valve coupling element 553 moves upwards and unlocks the hydrogen cylinder 551. Also, the moveable shield 554 moves upwards. The user can remove the hydrogen cylinder 551.

FIG. 8 shows a schematic view of a vehicle combination 1 with a drone box 300. The vehicle combination 1 comprises a trailer 200 and a vehicle 100.

The trailer cable 112 is further connected to the drone box 300, which is mounted to the trailer 200. The trailer 200 and the drone box 300 are part of a trailer with a drone box system 10.

The trailer 200 comprises connection means 201 to take up the drone box 300. The connection means 201 can be eyelets and/or fastening hooks. The connections mean 201 can be arranged on a bottom plate, which is not shown here, of the trailer 200.

The drone box 300 can also comprise fastening elements, which are not shown here, corresponding to the connection means 201. The drone box 300 is arranged on the bottom plate of the trailer 200. The drone box 300 is connected with the trailer cable 112 to the electric power storage 111. The drone box 300 drains energy through the trailer cable 112 from the power storage 111.

The drone box 300 further comprises a cover 301. The cover 301 is adapted to move sideways to open a top of the drone box 300. The cover 301 unblocks a platform 302 of the drone box 300. The platform 302 is a landing platform. The platform 302 is adapted to take up a drone 400. The platform 302 is adapted to lift the drone 400. The platform can be lifted by a scissor lift. The platform 302 can be lowered to take up the drone 400 inside the drone box 300. After and/or before taking up the drone 400 the cover 301 can be closed or opened.

The drone 400 can be driven by a fuel cell, which is not shown here. The fuel cell can be a hydrogen fuel cell. In an embodiment, not shown here, the drone 400 can be also driven by a battery or combustion engine. For taking up hydrogen the drone 400 comprises a fuel tank 401. The fuel tank 401 can store hydrogen. The hydrogen can be liquid.

The drone box 300 comprises a hydrogen hose 331. The hydrogen hose 331 is connected to the fuel tank 401. The hydrogen hose 331 conveys hydrogen from the drone box 300 to the hydrogen cylinder.

In an embodiment, not shown here, the hydrogen hose 331 can be an electric cable to provide electric energy to the drone 400. In particular, the hydrogen hose 331 can be connected to the fuel tank 401 automatically.

FIG. 9 shows a schematic view of a drone box 300 while refilling a drone 400 as shown in FIG. 1.

The drone box 300 produces hydrogen. The drone box 300 comprises a compressor. The compressor can be a pump 310. The compressor pump 310 is electrical connected to the power of the electric power storage 111 through the trailer cable 112. The pump 310 pumps water to a hydrogen producing unit 320.

The water can be stored in a water storage, which is not shown here. The water storage can be part of the drone box 300 or can be arranged externally. For example, the water tank can be arranged on the trailer 200 or the car 100.

The pump 310 pulls water from the water storage through a water hose, which is not shown here. The water is pumped through a pump hose 311. The pump hose 311 is connected to the compressor pump 310 and the hydrogen producing unit 320. The pump 310 pumps water through the pump hose 311 into the hydrogen producing unit 320.

The hydrogen producing unit 320 takes up the provided water and converts the water with electric power provided from the electric power storage 112 through the trailer cable 112 into hydrogen. The hydrogen producing unit 320 can perform an electrolysis. In another embodiment, which is not shown here, hydrogen can be produced by methane pyrolysis, partial oxidation, or plasma reforming. The hydrogen can also be produced from the reaction of a chemical and water.

In particular, the produced hydrogen can be liquid. Additionally, a liquefier, which is not shown here, can convert the produced hydrogen into a liquid.

The liquid hydrogen can be stored in a hydrogen tank 330. The liquid hydrogen is conveyed through a hydrogen producing unit hose 321 to the hydrogen tank 330. The hydrogen producing unit hose 321 is connected to the hydrogen producing unit 320 and the hydrogen tank 330.

The liquid hydrogen stored in the hydrogen tank 330 is conveyed through a hydrogen hose 331 to the drone 400, in particular to the fuel tank 401 of the drone 400.

FIG. 10 shows a schematic cross section view of a drone box 300, as shown in FIG. 2, in closed status with a drone 400 taken up.

The drone box 300 comprises the platform 302. While the cover 301 is open, which is not shown here, the platform 302 is raised. The drone 400 can land on the platform 302. The platform 302 can be lowered. The drone 400 is taken up on the inside of the drone box 300. When the drone 400 is taken up, the cover 301 can close. This allows transporting the drone 400 on the trailer 200. The drone 400 can be also refilled on the inside of the drone box 300.

FIG. 11 shows a schematic top view of the trailer 200 with the drone box 10 as shown in FIG. 1.

The drone box 300 is arranged on the bottom plate of the trailer 200. The bottom plate comprises connections means 201. The connection means 201 can be arranged around the drone box 300. In the embodiment, which is shown in FIG. 4, the trailer 200 comprises four connections means 201. The number of connections means 201 is not limited to four. The drone box 300 can comprise fastening elements, which are not shown here, corresponding to the connection means 201. The drone box 300 can be aligned and mounted on the trailer 200 through the connection means 201 and the fastening elements.

FIG. 12 shows a schematic view of a drone box 300, as shown in FIG. 9, with a tethering module 340 connected to a drone 400.

The drone box 300 can comprise the tethering module 340 additional or alternatively to the compressor pump 310, the hydrogen producer 320, and the hydrogen tank 330. The tethering module is connected to the drone 400 through a tethering cable 341. The tethering cable can comprise a length of 300 meters. While the drone 400 is flying the tethering module 340 is still connected to the drone 400 through the tethering cable 341. The tethering module 340 transmits control commands to the drone 400.

In an embodiment, wherein the drone 400 is battery-driven, the tethering cable 401 can provide electric power to the drone 400.

The drone 400 comprises a navigation module 410. The navigation module 410 can be a Universal Transverse Mercator (UTM). The navigation module can control the drone 400. The drone 400 can fly along a predefined course using the navigation module 410. The navigation module 410 determines the current position of the drone 400. The navigation module 410 can communicate with the tethering module 340.

FIG. 13 shows a schematic view of a drone box 300, as shown in FIG. 9.

The compressor pump 310, the hydrogen producing unit 320, and the hydrogen tank 330 are not shown here. The drone box 300 comprises the tethering module 340, as shown in FIG. 12.

The drone box 300 further comprises a power module 340. The power module 340 can provide electric power for the drone box 300 and the drone 400. The compressor pump 310, the hydrogen producing unit 320, and the hydrogen tank 330 can be part of the power module 350.

The drone box 300 further comprises a heating module 360. The heating module can provide heat to the drone box 300. The heating module 360 controls a temperature of the drone box 300.

The heating module comprises a central system module 361. The central system module 361 controls the drone box 300. The central system module 361 controls the cover 301 and modules.

The drone box 300 also comprises a cooling module 370. The cooling module 370 removes heat from the drone box 300.

A wall module 380 is connected to the heating module 360 through a heating hose 381. The wall module 380 is also connected to the cooling module 370 through a cooling hose 382. The heating module 360 provides heat to the wall module 380. The cooling model 370 provides coolness to the wall module 380. The wall module 380 is a temperature absorber. The wall module 380 can be a heating element or a cooling element. The wall module 380 controls a temperature of a wall of the drone box 300.

FIG. 14 shows a schematic view of a drone box 300, as shown in FIG. 13, with a payload module 390.

The payload module 390 provides a payload to the drone 400. The payload module 390 can change or replace the payload of the drone 400. The payload module 390 can provide weapons, payload and/or technical equipment to the drone 400. For example, the payload module 390 can mount a camera to the drone 400. The payload module 390 can equip the drone 400 depending on the use case of the drone 400.

In case the drone 400 landed on the platform 302 the control system unit 361 can detect the drone 400. Depending on predefined settings the control system unit 361 can close the cover 301. The power module 350 can provide power to the drone 400. The power can be electricity or hydrogen. The heating module 360, the cooling module 370, and the wall module 380 can regulate a temperature inside the drone box 400. The temperature is also absorbed to the drone 400. Depending on the temperature the drone 400 can be heated, cooled, or de-iced. De-icing the drone 400 improves the flight characteristics of the drone 400.

In case the drone 400 is ready for taking off the control system unit opens the cover 301 and releases the drone 400.

The modules 340, 350, 360, 370, 380 are exchangeable. The modules 340, 350, 360, 370, 380 can be changed depending on the use case of the drone 400. The drone box 300 is exchangeable.

FIG. 15 shows a schematic view of drone box 300 with tethering module 340, a power module 350, a compressor pump 310, a hydrogen producing unit 320, and a hydrogen tank 330.

As shown in FIG. 9, the drone 400, which is not shown here, lands on the platform 302. The tethering module 340, as shown in FIG. 5, is already connected to the drone 400. Otherwise, the tethering module 340 can be connected to the drone 400. The tethering module 340 communicates with the drone 400. The tethering module 340 requests status information. For example, the tethering module can request a state of charge or a status of the drone 400.

Depending on the status information the power module 350, as shown in FIG. 12, determines if charging or refilling the drone 400 is required. In case hydrogen must be refilled, the power module 350 can control the compressor pump 310 to pump water into the hydrogen producing cell 320 through the hose 311. The power module 350 can also control the hydrogen producing cell 320. The power module 350 provides electric power to the hydrogen producing cell 320. The hydrogen is stored in a hydrogen tank 330. This process can take place when the drone 400 landed or even before landing the drone 400.

The power module 350 can further establish a connection to the drone 400 to transfer hydrogen to the drone 400.

FIG. 16 shows a schematic view of drone box 300 with a payload module 390, a power module 350, a compressor pump 310, a hydrogen producing unit 320, and a hydrogen tank 330.

The power module 350 controls the compressor pump 310, the hydrogen producing unit 320, and the hydrogen tank 330, as described above.

The payload module 390 is adapted to attach payload, which is not shown here, to the drone 400, which is also not shown here. The payload module 390 is configured depending on the use case of the drone 400. For example, the payload module 390 comprises a bomb load, weapons, technical equipment, in particular cameras, sensors or motors, and/or a payload. The payload module can also comprise a robot arm, which is not shown here, to mount a load to the drone 400. The robot arm can work automatically. Depending on the use case of the drone 400 a camera can be mounted, or an additional sensor can be installed. If a part of the drone 400 is damaged, the part can be changed.

The power module 350 and the payload module 390 can work at the same time.

FIG. 17 shows a schematic view of drone box 300 with a power module 350, a heating module 360, a cooling module 370, a wall module 380, a compressor pump 310, a hydrogen producing unit 320, and a hydrogen tank 330.

The power module 350 controls the compressor pump 310, the hydrogen producing unit 320, and the hydrogen tank 330, as shown in FIG. 15.

The drone box 300 can additionally comprise the heating module 360, the cooling module 370, and the wall module 380. The heating module 360, the cooling module 370, and the wall module 380 can form a heating system. The heating module 360, the cooling module 370, and the wall module 380 are independent and can be changed modular.

The tethering module 340, the power module 350, the heating module 360, the cooling module 370, the wall module 380, and the payload module 390 are modular changeable. The modules 340, 350, 360, 370, 380, 390 can be combined in any way. The number of built-in modules is not limited to a maximum or a minimum.

The tethering module 340 can be built-in depending on the use case and/or local restrictions. The tethering module 340 can be combined with the power module 350. The power module can provide electric power to the drone 400 through the tethering cable 341. In particular, the electric power can be provided to the flying drone 400. This improves the flight time.

The heating module 360, the cooling module 370, and the wall module 380 can be combined with the heating system. The heating system can control the temperature of the drone box 300. The heating system can also be combined with the tethering module 340 and/or the power module 350, as described above.

Independent of any combination, as described above, the payload module 390 can be built in. The payload module 390 allows configuring the drone 400 depending on the use case.

In case the drone 400 is driven by hydrogen, the compressor pump 310, the hydrogen producing unit 320, and the hydrogen tank 330 can be built in the drone box 300. The compressor pump 310, the hydrogen producing unit 320, and the hydrogen tank 330 can be combined with the power module 350. In this case, the power module 350 controls the hydrogen producing unit 320.

The heating module 360 comprises a central system unit 361. The central system unit 361 controls the heating system. Depending on weather conditions the central system unit 361 heats or cools the drone box 300. The wall module 380 is adapted to climate the walls of the drone box 300. In case a cover 301 is closed the heating system can also climate the drone 400.

In a first step, the cover 301 of the drone box 300 opens. In a further step the drone 400 lands on the drone box 300, in particular on the platform 302 of the drone box 300.

In a further step, the central system module 361 can determine if it is required to heat or cool the drone 400 and/or the drone box 300. Depending on the determining the central system module 361 can close the cover 301. Depending on the work, which has to be done on the drone 400, the drone 400 can be lifted, in particular, lowered by a scissor lift, which is not shown here. The scissor lift is optional. In case the tethering module 340 is built in the drone box 300, the tethering module 340 can connect to the drone 400. The connection can perform automatically. In this case, the tethering module 340 communicates with the drone 400. The tethering module 340 requests status information from the drone 400, as described above. In case the tethering module 340 is not built-in, the central system module can communicate with the drone 400. The communication with the drone 400 can be wireless, for example, Bluetooth or wireless LAN. Depending on the provided status information the central system unit can decide if it is required to climate the drone, as described above.

In a further step, the power module 350 calculates if it is required to refill the drone 400 depending on the upcoming use case of the drone 400. The upcoming use case can either be entered into the drone box 300 or directly to the drone 400.

In a further step the power module 350 controls the compressor pump 310, the hydrogen producing unit 320, and the hydrogen tank 330, as shown in FIG. 8 and described above.

In a further step, the payload module 390 attaches the payload, as described above, to the drone 400.

The steps described above can take place at the same time and/or one step after the other. The steps can depend on the built-in modules in the drone box 300.

In another embodiment, the hydrogen cylinder 551 is connected directly to the drone 400. This solution provides fast changing of the fuel tank 401. As a result, the drone 400 is faster refilled and ready for takeoff.

FIG. 18 shows a trailer 600. The trailer 600 includes a box body 603 mounted on a trailer chassis 605 with wheels 607. The box body 603 stores and encloses equipment 610. The box body 603 is attached to the trailer chassis 605 while the trailer chassis 605 is supported by the wheels 607.

In detail, the equipment 610 includes a water reservoir 612, a reverse osmosis filter 615, an electrolyzer 617 with wire rope isolators 620, a hydrogen dryer 622 with a hydrogen pipe 624, a low-pressure hydrogen gas buffer cylinder 627, a compressor 630 with a high-pressure hydrogen gas buffer bunker 633, a refuelling connector 635 with a safety valve 637, and a start/stop button 638.

Moreover, the equipment 610 also includes a programmable logic controller (PLC) 641, a power line or supply 644, and equipment communication channels. The equipment communication channels are not shown in FIG. 18.

The box body 603 has a door 648, and a mechanical ventilation 651 with hydrogen leak detectors 654.

The water reservoir 612 is placed next to the door 648. The reverse osmosis filter 615 is connected to the water reservoir 612. The electrolyzer 617 is connected to the reverse osmosis filter 615 and it is supported by the wire rope isolators 620. One end of the hydrogen pipe 624 is connected to the electrolyzer 617. The hydrogen dryer 622 is connected to another end of the hydrogen pipe 624.

The low-pressure hydrogen gas buffer cylinder 627 is connected to the hydrogen dryer 622. The compressor 630 is connected to the low-pressure hydrogen gas buffer cylinder 627. The high-pressure hydrogen gas buffer bunker 633 is connected to the compressor 630.

A high-pressure hydrogen gas pipe is connected to the high-pressure hydrogen gas buffer bunker 633. The high-pressure hydrogen gas pipe is not shown in FIG. 18. The refuelling connector 635 is connected to the high-pressure hydrogen gas pipe. The safety valve 637 is connected to the refuelling connector 635.

The door 648 is mounted to a vertical surface of the box body 603. The mechanical ventilation 651 is mounted to a top surface of the box body 603. The hydrogen leak detectors 654 are placed in an inner area of the box body 603.

The PLC 641 and the power supply 644 are electrically connected to parts of the equipment 610.

In use, the box body 603 is used for storing the equipment 610.

The door 648 allows an operator to feed or add water into the water reservoir 612. The water reservoir 612 stores liquid unfiltered water. The reverse osmosis filter 615 acts to remove contaminants from the unfiltered water. The electrolyzer 617 transforms the filtered water into hydrogen gas. The wire rope isolators 620 reduce or prevent unwanted vibration from reaching the electrolyzer 617. The hydrogen pipe 624 allows hydrogen gas flows from one end to another end of the pipe.

The hydrogen dryer 622 removes humidity from the produced hydrogen gas. The low-pressure hydrogen gas buffer cylinder 627 stores the dried hydrogen gas from the hydrogen dryer 622 at low pressure. The compressor 630 then boosts or increases the pressure of the hydrogen gas from the low-pressure hydrogen gas buffer cylinder 627 to high pressure. The high-pressure hydrogen gas buffer bunker 633 stores the compressed hydrogen gas at high pressure. The refuelling connector 635 is used for connecting to an empty or partially empty cylinder 660 for refuelling.

The safety valve 637 prevents any pressure in the refuelling connector 635 from surging above a predetermined limit. The start/stop button 638 acts to actuate the refuelling of the cylinder 660.

The mechanical ventilation 651 removes any leaked hydrogen from the box body 603 to mitigate or reduce risks related to leaked hydrogen. The hydrogen leak detectors 654 measure the presence of the concentration of hydrogen in the air inside the box body 603.

The PLC 641 coordinates operations of the equipment 610. The power supply 644 provides electrical power to the equipment 610. The communication channels act to command and control the equipment 610.

The embodiments can also be described with the following lists of features or elements being organized into an item list. The respective combinations of features, which are disclosed in the item list, are regarded as independent subject matter, respectively, that can also be combined with other features of the application.

1. A hydrogen producing cube for refilling a hydrogen cylinder, wherein the hydrogen producing cube comprises
a hydrogen cylinder holder,
a compressor unit,
an electrolyzer unit, and
a liquefier unit.
   2. Hydrogen producing cube according to item 1, wherein the hydrogen producing cube further comprises a human interface device.
   3. Hydrogen producing cube according to one of the previous items, wherein the hydrogen producing cube further comprises a status display.
   4. Hydrogen producing cube according to one of the previous items, wherein the hydrogen producing cube further comprises a connection interface.
   5. Hydrogen producing cube according to one of the previous items, wherein the hydrogen cylinder holder further comprises a moveable valve coupling element.
   6. Hydrogen producing cube according to one of the previous items, wherein the hydrogen cylinder holder further comprises a moveable shield.
   7. Hydrogen producing cube according to one of the previous items, wherein the hydrogen producing cube further comprises electric cable.
   8. Hydrogen producing cube according to one of the previous items, wherein the hydrogen producing cube further comprises a water hose.
   9. Hydrogen producing cube according to one of the previous items, wherein the hydrogen producing cube further comprises a water tank.
   10. Hydrogen producing cube according to one of the previous items, wherein the hydrogen producing cube further comprises an energy storage.
   11. A trailer comprising a hydrogen producing cube according to one of the previous items, wherein the trailer further comprises
connections means,
a tow bar and
a trailer cable.
   12. A vehicle combination comprising a trailer according to item 10 and a hydrogen producing cube according to item 1 to 10, wherein the vehicle combination further comprises a vehicle, wherein the vehicle comprises
a motor,
a generator,
a generator cable, and
an electric power storage.
   13. A drone box for a drone, wherein the drone box comprises
a compressor,
a compressor hose,
a hydrogen producing unit,
a hydrogen producing unit hose,
a hydrogen tank,
a hydrogen tank hose, and
a platform.
   14. Drone box according to item 13, wherein the drone box further comprises a water tank.
   15. Drone box according to one of the items 13 to 14, wherein the platform is mounted to a scissor lift.
   16. Drone box according to one of the items 13 to 15, wherein the drone box further comprises a cover, wherein the cover has a shape of a hood in cross section.
   17. Drone box according to one of the items 13 to 16, wherein the hydrogen producing unit is an electrolyzer.
   18. Drone box according to one of the items 13 to 17, wherein the drone box further comprises modular changeable modules.
   19. Drone box according to item 18, wherein the modular changeable modules are a payload module, a power module, a heating module, a central system module, a cooling module, a heating module and/or a wall module.
   20. Drone box according to item 18 or 19, wherein the drone box further comprises a tethering module with a tethering cable.
   21. Drone box according to one of the items 13 to 20, wherein the hydrogen tank is exchangeable.
   22. Drone box according to one of the items 13 to 21, wherein the drone box further comprises a liquefier.
   23. A trailer comprising a drone box according to one of the items 13 to 22, wherein the trailer further comprises
connections means,
a tow bar, and
a trailer cable.
   24. A trailer with a drone box, wherein the drone box is exchangeable.
   25. A vehicle combination comprising a trailer according to item 23 to 24 and a drone box according to item 13 to 22, wherein the vehicle combination further comprises a vehicle, wherein the vehicle comprises
a motor,
a generator,
a generator cable, and
an electric power storage.
   26. A method for refilling a drone with a drone box, wherein the method comprises the following steps
pumping water from a water tank to a hydrogen producing unit,
producing hydrogen in the hydrogen producing unit,
liquefying the hydrogen in a liquefier,
storing the hydrogen in a hydrogen tank, and
refilling the drone with hydrogen from the hydrogen tank.
   27. A method according to item 26, wherein the method comprises the further step of attaching a payload to the drone with a payload module.

Although the above description contains much specificity, this should not be construed as limiting the scope of the embodiments but merely providing illustration of the foreseeable embodiments. The above stated advantages of the embodiments should not be construed especially as limiting the scope of the embodiments but merely to explain possible achievements if the de-scribed embodiments are put into practice. Thus, the scope of the embodiments should be determined by the claims and their equivalents, rather than by the examples given

### REFERENCE NUMBERS

1 vehicle combination
10 trailer with a drone box
100 vehicle
101 motor
102 generator
110 generator cable
111 electric power storage
112 trailer cable
120 tow bar
200 trailer
201 connection means
300 drone box
301 cover
302 platform
310 pump
311 pump hose
320 hydrogen producing unit
321 hydrogen producing unit hose
330 hydrogen tank
331 hydrogen hose
340 tethering module
341 tethering cable
350 power module
360 heating module
361 central system module
370 cooling module
380 wall module
381 heating hose
382 cooling hose
390 payload module
400 drone
401 fuel tank
410 navigation module
500 hydrogen producing cube
501 canopy
510 electric cable
511 connection interface
512 energy storage
520 water hose
521 water tank
530 electrolyzer unit
531 compressing unit
532 liquefying unit
533 hydrogen hose
540 human interface device
550 hydrogen cylinder holder
551 hydrogen cylinder
552 hydrogen cylinder valve
553 moveable valve coupling element
554 moveable shield
560 status display
600 trailer
603 box body
605 trailer chassis
607 wheels
612 water reservoir
615 reverse osmosis filter
617 electrolyzer
620 wire rope isolators
622 hydrogen dryer
624 hydrogen pipe
627 low-pressure hydrogen gas buffer cylinder
630 compressor
633 high-pressure hydrogen gas buffer bunker
635 refueling connector
637 safety valve
638 start/stop button
641 PLC
644 power supply
648 door
651 mechanical ventilation
654 hydrogen leak detector
660 cylinder

1. A trailer comprising
a hydrogen producing cube for refilling a hydrogen cylinder, the hydrogen producing cube comprises
a hydrogen cylinder holder,
a compressor unit,
an electrolyzer unit, and
a liquefier unit,
connections means,
a tow bar, and
a trailer cable.

2. The trailer according to claim 1, wherein
the hydrogen producing cube further comprises a human interface device.

3. The trailer according to claim 1, wherein
the hydrogen producing cube further comprises a status display.

4. The trailer according to claim 1, wherein
the hydrogen producing cube further comprises a connection interface.

5. The trailer according to claim 1, wherein
the hydrogen cylinder holder further comprises a moveable valve coupling element.

6. The trailer according to claim 1, wherein
the hydrogen cylinder holder further comprises a moveable shield.

7. The trailer according to claim 1, wherein
the hydrogen producing cube further comprises electric cable and/or wherein the hydrogen producing cube further comprises a water hose.

8. (canceled)

9. The trailer according to claim 1, wherein
the hydrogen producing cube further comprises a water tank and/or wherein the hydrogen producing cube further comprises an energy storage.

10. (canceled)

11. A vehicle combination comprising
a trailer according to claim 1, a motor,
a generator,
a generator cable, and
an electric power storage.

12. A trailer comprising
a drone box for a drone, wherein the drone box comprises
a compressor unit,
a compressor hose,
a hydrogen producing unit,
a hydrogen producing unit hose,
a hydrogen tank,
a hydrogen tank hose, and
a platform,
connections means,
a tow bar, and
a trailer cable.

13. The trailer according to claim 12, wherein
the drone box further comprises a water tank.

14. The trailer according to claim 12, wherein
the platform is mounted to a scissor lift.

15. The trailer according to claim 12, wherein
the drone box further comprises a cover, wherein the cover has a shape of a hood in cross section.

16. The trailer according to claim 12, wherein
the hydrogen producing unit is an electrolyzer and/or wherein the drone box further comprises modular changeable modules.

17. (canceled)

18. The trailer according to claim 16, wherein
the modular changeable modules are a payload module, a power module, a heating module, a central system module, a cooling module, a heating module and/or a wall module.

19. The trailer according to claim 16, wherein
the drone box further comprises a tethering module with a tethering cable.

20. The trailer according to claim 12, wherein
the hydrogen tank is exchangeable and/or wherein the drone box further comprises a liquefier.

21. (canceled)

22. (canceled)

23. (canceled)

24. A trailer comprising
a box body for storing equipment, the box body being mounted on a trailer chassis with wheels,
the equipment comprising
a water reservoir for storing water,
an electrolyzer unit for transforming the water into hydrogen gas,
a hydrogen gas buffer unit for storing the hydrogen gas at low pressure,
a compressor unit for increasing the pressure of the hydrogen gas to high pressure,
a hydrogen gas buffer bunker unit for storing the hydrogen gas at high pressure,
a refuelling connector for connecting the hydrogen gas to a cylinder for refuelling,
a controller for sending commands to the equipment, and
a power supply for providing electrical power to the equipment.

25. The trailer according to claim 24, wherein
the equipment further comprising
a reverse osmosis filter for removing contaminants from the water,
a plurality of a wire rope isolators for reducing vibrations from reaching the electrolyzer unit,
a hydrogen dryer for removing humidity from the hydrogen gas,
a safety valve for preventing any pressure in the refuelling connector from surging above a predetermined limit,
a start/stop button for actuating the refuelling of the cylinder, and
a hydrogen pipe for allowing hydrogen gas to flow from one component to another end of the equipment.

26. The trailer according to claim 24 wherein,
the box body comprising
a door for allowing an operator to add water into the water reservoir.
a mechanical ventilation for removing any leaked hydrogen from the box body, and
a hydrogen leak detector for measuring the presence of the concentration of hydrogen inside the box body.

27. (canceled)
